(19) United States
(12) Patent Application Publication
(10) Pub. No.: US 2008/0004908 A1
(43) Pub. Date: Jan. 3, 2008

(54) RFID Medical Supply Monitoring And Tracking System

(75) Inventors: Cheng Guan Michael Oh, Singapore (SG); Boon Wee Quek, Singapore (SG); Lee Ying Ng, Singapore (SG); Chee Sheng Chua, Singapore (SG); Ye Gu, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: TCM RFID Pte Ltd, Singapore (SG)

(21) Appl. No.: 11/768,932

(22) Filed: Jun. 27, 2007

Related U.S. Application Data
(60) Provisional application No. 60/805,873, filed on Jun. 27, 2006.

(51) Int. Cl. G06Q 50/00

(52) U.S. Cl. 705/2; 340/572.1

(57) ABSTRACT

The present invention provides a medical supply monitoring and tracking system (100). In one embodiment, the system (100) includes a medicine trolley (300). A storage compartment (312,314,316) of the medicine trolley (300) has two RFID antennae (340) aligned substantially orthogonal to each other for monitoring a RFID tag (360) on each medical supply (350). In another embodiment, the system (100) also includes a communication device (210) and a staff identification card (222). The communication device (210) includes a functional module, each relevant for a doctor (223), a nurse (225), a pharmacist (224), and so on.

### FIELD OF INVENTION

The present invention relates to medicine and medical consumables monitoring and tracking system. In particular, the invention relates to a system for electronic monitoring and tracking of medicines by tagging each item with RFID tags and tracing the handling of each item by a health care staff.

### BACKGROUND

Fatality among patients due to errors in prescription of pharmaceutical products is on the rise. Such errors are often due to human errors. For example, a nurse may give a patient a medicine by mistake, or in the wrong dose. Similarly, a doctor may prescribe a drug to a patient without referring to the patient's allergy records.

To minimize some of these medical errors from recurring, most of the hospitals are required to label each bottle or box containing medicine with a bar-code. These bar-codes have limited information that can be encoded. To overcome some of these problems, each bottle or box containing medicine may be labeled with more than one bar-code labels, for example, one to identify the medicine, another to identify its expiry date, and yet another to identify its manufacturing date and batch number. Even with bar-coding of medicines, the safety and standard of health care are still dependent on human conscientiousness in its implementation.

It can thus be appreciated that there is a need to find a safe alternative to bar-coding of medical supplies and consumables in the health care industry. For example, when a nurse takes out a bottle of medicine from a trolley or medicine chest by mistake, it is desirous to have a system to alert the nurse. It is also desirous to have a system to record and trace the dispensing of medicines by various staffs of a health care institution. A possible technology for use in such a system may be radio frequency identification or RFID for short.

US patent publication no. 2006/0089858 by Tun Ling discloses a system for applying RFID and PKI (public Key Infrastructure) technologies for patient health safety by installing RFID tags and reader on a medicine-storing chests. The RFID reader senses the RFID tags on medicine containers, and transmits information on the medicine usage and movement to a central database.

It can thus be seen that there exists a need for a safe system for automatically identifying, tracking, recording and managing the use of medical supplies and consumables, such as medicine, when providing health care.

### BRIEF DESCRIPTION OF THE DRAWINGS

This invention will be described by way of non-limiting embodiments of the present invention, with reference to the accompanying drawings, in which:

FIG. 1 illustrates an overall electronic record system of a health care institution;

FIG. 2 illustrates a portable communication device for use by a staff of the health care institution shown in FIG. 1;

FIG. 3A shows a medical trolley according to an embodiment of the present invention; FIG. 3B shows the electrical connection of a RFID reader and wireless communication on the medical trolley shown in FIG. 3A;

FIG. 4 shows a process flow of a doctor module according to another embodiment of the present invention;

FIG. 5 shows a process flow of a pharmacist module according to another embodiment of the present invention;

FIG. 6A shows a process flow of a nurse module according to yet another embodiment of the present invention; FIGS. 6B-6F illustrates process flows in an implementation of the process in FIG. 6A; and

FIG. 7A shows a screen shot illustrating a medication administration function in the nurse module shown in FIGS. 6A-6F; and

FIG. 7B shows a screen shot illustrating ordering of medical supplies function in the nurse module shown in FIGS. 6A-6F.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

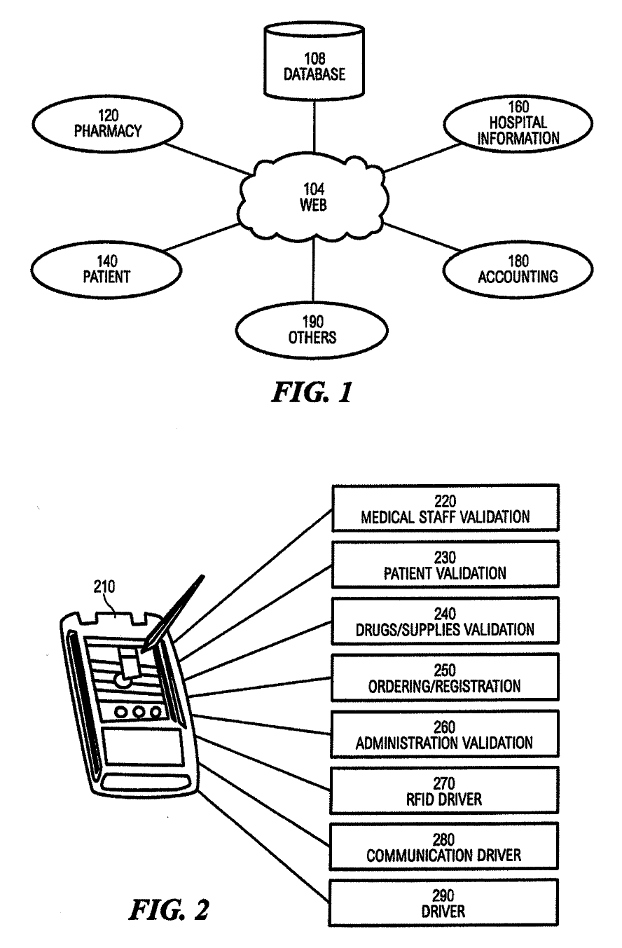

FIG. 1 shows an architecture of a hospital electronic record system 100. As shown in FIG. 1, the hospital record system 100 is divided into functional sub-record systems, such as a pharmacy records 120, patient records 140, hospital information records 160, accounting records 180 and other records 190. These sub-record systems are enumerated solely for purposes of describing the present invention, and there is no attempt to describe the functioning of an entire hospital. In addition, the record system 100 is linked by a web link 104 to a central database 108.

As shown in FIG. 1, the hospital record system 100 is hosted on the web 104, such as, an intranet 104. The intranet 104 may communicate with the various sub-record systems 120, 140, 160, 180, 190, database 108 and all communication interface devices 200, output devices (not shown in FIG. 1) and accessories (not shown in FIG. 1) via cable communication, wireless communication, or a combination of cable and wireless communication. In another embodiment, the hospital record system 100 is hosted by a web service.

Each communication device 210 may be a computer terminal, a portable digital assistant (PDA), a notebook, a mobile phone and so on, each device having a display screen and an input means. For illustration, FIG. 2 shows a communication device 210 issued to a hospital staff, such as, a doctor 223, a pharmacist 224, a nurse 225 or an administration staff 226. Each communication device 210 may be installed with a suite of softwares to interface with the hospital or enterprise record system 100. The suite of softwares include staff validation 220, patient validation 230, drug and supplies validation 240, ordering/requisition validation 250, administrative validation 260, RFID drivers 270, communication drivers 280 and other drivers 290. Each suite of softwares may be customized with different levels of accessing the hospital record system 100 according to the functional duties of each hospital staff. For example, the ordering/requisition validation 250 software running on a doctor's portable communication device 210 also has a prescription software functionality. In addition, each hospital staff is issued with a RFID enabled unique identification card (ID) 222. For example, a doctor 223 is issued with ID 222-3, a pharmacist 224 with ID 222-4, a nurse 225 with ID 222-5, and so on.

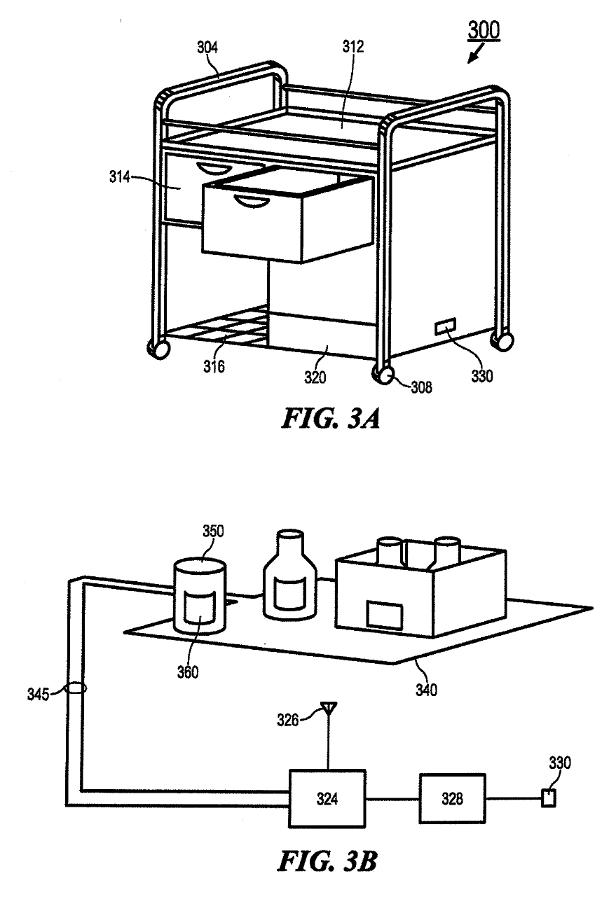

FIG. 3A shows a medicine trolley 300 according to an embodiment of the present invention. As shown in FIG. 3A, the medicine trolley 300 has a structural frame 304 supported on wheels 308. For illustration, each trolley 300 has an open-top tray 312, medicine drawers 314, an open-shelf 316 and a control compartment 320. Inside the control compartment 320 is a RFID controller 322, RFID reader 324, a wireless communication unit 326, and a battery 328. The bottom and a side of each drawer 314 each has a RFID antenna 340. Each RFID antenna 340 is connected to the RFID reader 324 by a co-axial cable 345. Below each antenna 340 is an electromagnetic shield 346. In addition, the battery 328 is connected to a plug 330 for external charging of the battery 328. FIG. 3B shows these electrical connections in the trolley 300. In another embodiment of the trolley 300, an embedded controller 323 is provided in addition to the controller 322. The embedded controller 323 allows the RFID reader 324 to continue sensing the contents of the medicine drawer 314 even when the trolley 300 is outside a wireless zone of the hospital record system 100.

Also as shown in FIG. 3B, each medicine bottle, container or box 350 is tagged with an RFID tag 360. Each RFID tag 360 has a coil 362 and a microchip 364. The microchip 364 carries a unique identification number and information on the medicine contained in the bottle, container or box 350. In use, the interrogating electromagnetic radio wave generated by the antenna 340 induces a voltage and current in the coil 362. This induced voltage and current supply power to the microchip 364 for it to send out a return signal through the coil 362. The return signal encoded with the information of the medicine is then reflected back to the antenna 340. The antenna 340 sends the return signal to the RFID reader 324. The RFID reader 324 extracts the information of the medicine from the return signal, encodes the information in a digital signal and sends it through the wireless communication unit 326 to the central database 108. The electromagnetic (EM) shield 346 confines the interrogating electromagnetic radio waves to detect the medicine and supply containers stored within each medicine drawer 314. The EM shield of any drawer overhead the relevant drawer also helps to confine the interrogating EM radio wave to within a medicine drawer 314. The EM shield 346 may be on a side of a storage compartment substantially separating it from an adjoining medicine compartment, be it a drawer, a top-shelf or an open shelf.

In another embodiment of the RFID antenna, each drawer 314 has two antennae 340. These two antennae 340 are placed substantially orthogonally to each other, with one on the base of the medicine drawer 314. The other antenna may be at either the left/right side or front/back panel of the medicine drawer 314. U.S. provisional application No. 60/805,877 filed by the same inventors on 27 Jun. 2006 is incorporated in its entirety in the present application.

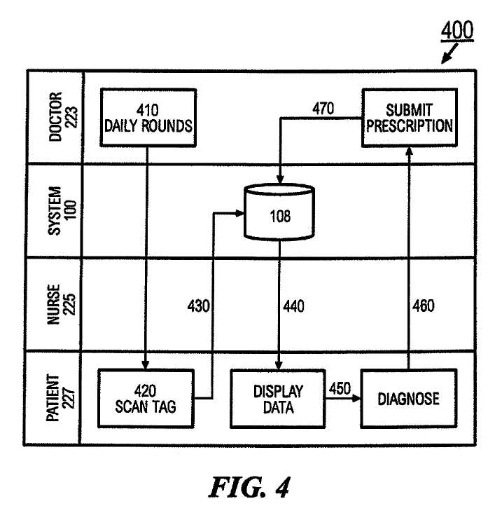

FIG. 4 shows a process flow for a doctor module 400 according to an embodiment of the present invention. As shown in FIG. 4, the doctor 223 visits his/her patients 227 during his/her daily rounds to a ward in step 410. When the doctor 223 attends to a patient 227, the doctor 223 scans, in step 420, a RFID tag 414 on the patient 227 with a portable RFID reader 418. In one embodiment, the doctor's portable RFID reader 418 is connected to the doctor's communication device 210. The doctor's communication device 210 sends out, in step 430, a validation signal to the central database 108. Once the doctor's communication device 210 is verified, the patient information stored in the patient's RFID tag 414 is then sent to the central database 108. Once the patient 227 is identified, the medical records of the patient are then sent, in step 440, from the central database 108 to the doctor's communication device 210. With the medical records displayed on the doctor's communication device 210, the doctor 223 assesses the patient's 227 condition in step 450. If there is a need, the doctor 223 prescribes medication to the patient 227 in step 460 through a prescription software 255 operating in the doctor's communication device 210. Once a prescription is issued, in step 470, by the doctor 223, the prescription is sent to the central database 108 for further processing, for example, by a pharmacist 224.

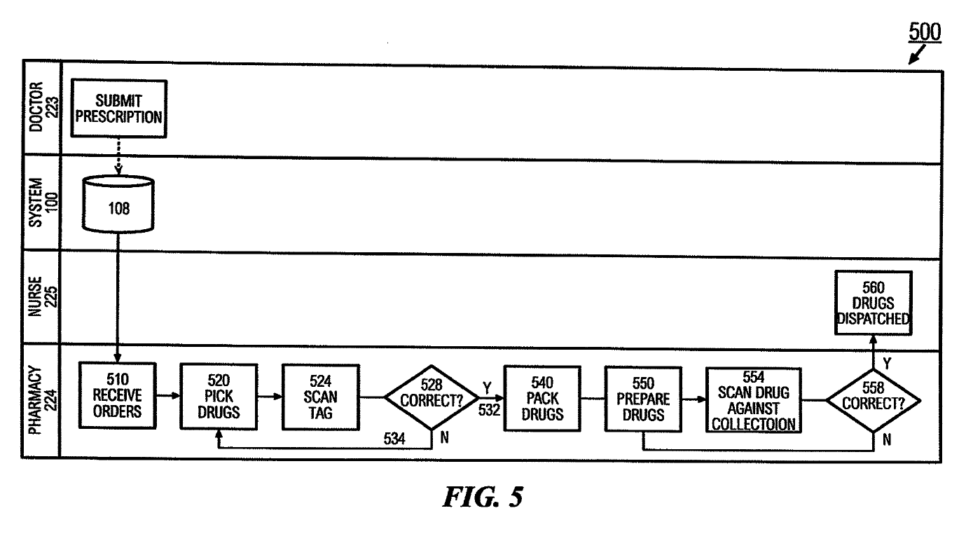

FIG. 5 shows a process flow for a pharmacist module 500 according to an embodiment of the present invention. As shown in FIG. 5, a doctor's prescription is received by a pharmacist 224, in step 510, from the central database 108. Upon receipt of the prescription, the pharmacist 224 studies the prescription and picks the drugs, in step 520, from the correct drug storage area. Once a drug supply container 522 is identified, the pharmacist 224 scans, in step 524, the RFID tag 360a on the container 522. The information of the drug contained in the RFID tag 360a is sent to the central database 108 for processing. Once the central database 108 is updated with the drugs as prescribed by the doctor 223, a RFID unit at the pharmacy outputs a RFID tag 360 to the pharmacist 224. The pharmacist 224 attaches, in step 524a, the RFID tag 360 onto a container 350 in which the prescribed drug is put into. Once this is done, the pharmacist 224 scans, in step 524b, the RFID tag 360 with his/her own communication device 210. The pharmacist's communication device 210 sends a validation signal to the central database 108. Once the pharmacist's identity 224 is verified, information of the prescribed drug is sent to the central database 108 for verification against the doctor's prescription, in step 528. If the drug is corrected picked by the pharmacist 224, the system 100 affirms, in step 532, and the pharmacist 224 proceeds to pack the medication into a medicine drawer 314 for a particular patient 227. If the drug picked by the pharmacist 224 is incorrect, the system 100 would alert the pharmacist 224, in step 534, so that the pharmacist can take corrective action. The pharmacist 224 continues to prepare all the medication for this patient 227 and puts all of them into the same medical drawer 314 in step 550. The pharmacist may also consolidate the medication for other patients staying in the same ward as the earlier one into one medicine drawer 314 as space allows. Once a medicine trolley 300 for a particular ward is stocked up with prescribed medication and other consumables by a pharmacist 224, the RFID antennae 340 in each medicine drawer 314 scan, in step 554, the RFID tags 360 on the containers 350 of the medicines/consumable supplies and verify, in step 558, with the information in the central database 108. If the verification is positive, the pharmacist 224 scans his/her identity card 222-4 and the central database 108 is updated; the medicine trolley 300 is then moved to a drug discharge area in step 560. If the prescribed medication and medical supplies do not tally with the information in the central database 108, the pharmacist 224 is alerted and correction action follows. After a medicine trolley 300 for a particular ward is ready for dispatch, the nursing station in the relevant ward is notified.

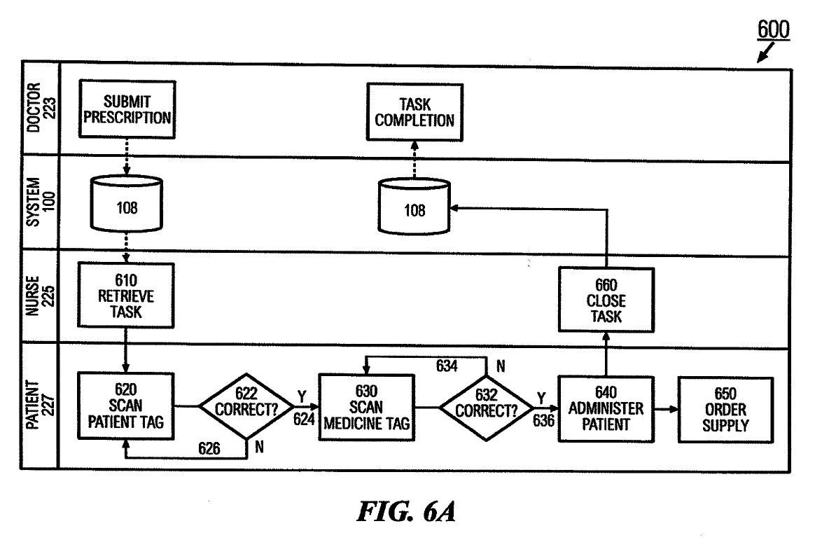

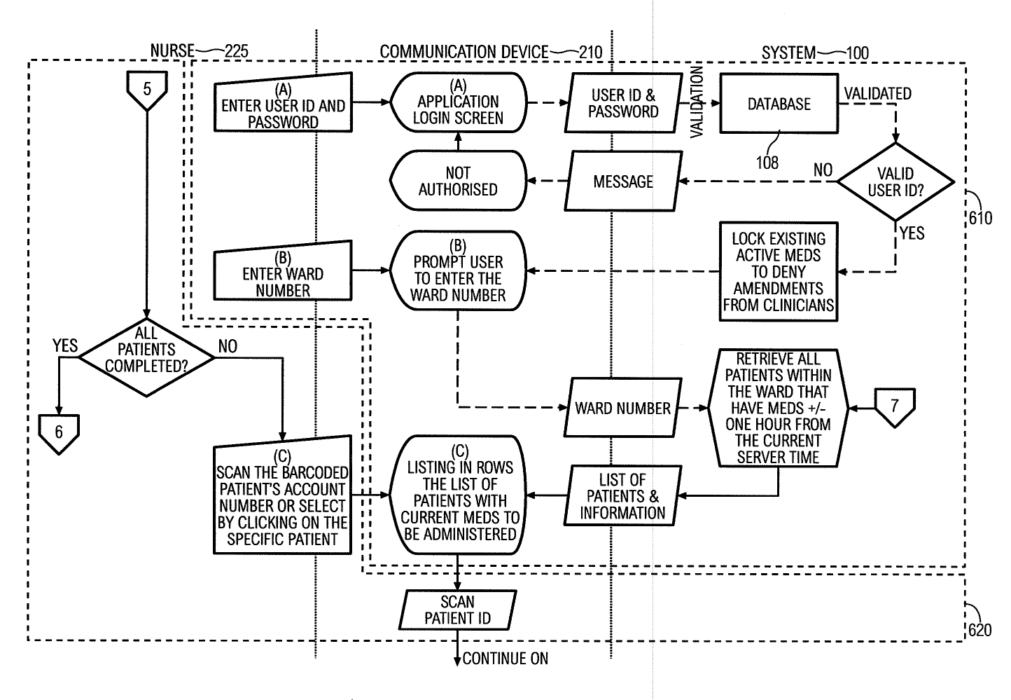

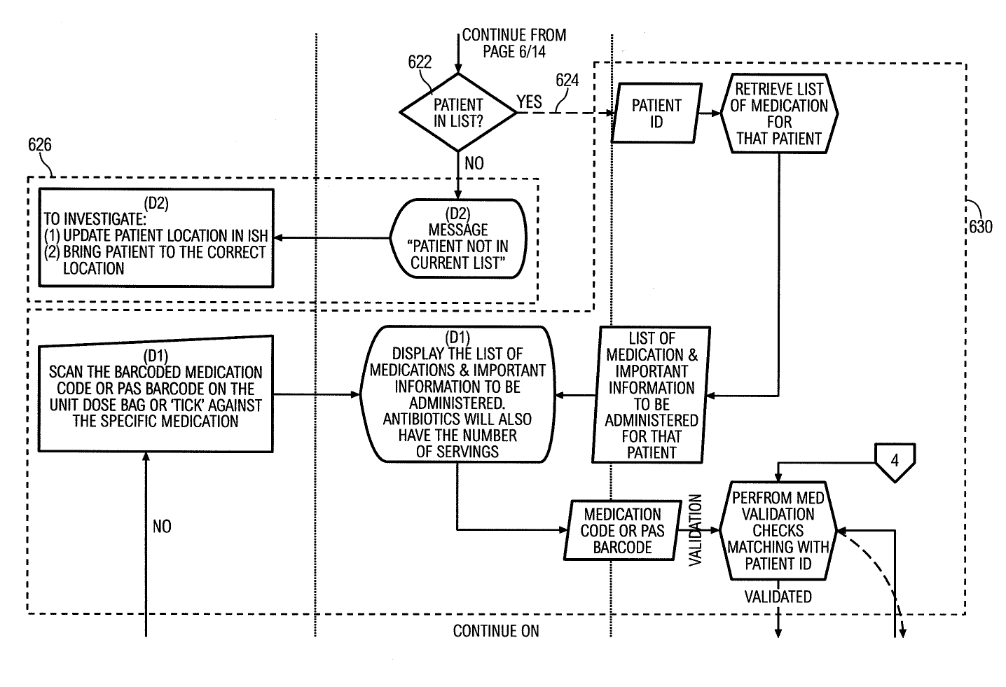

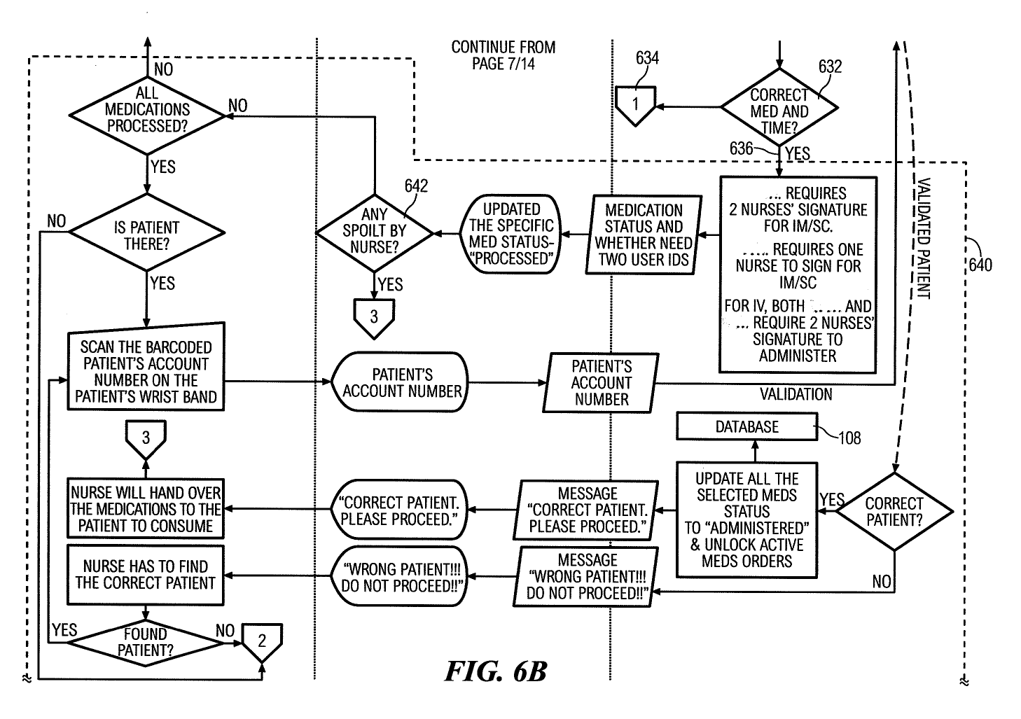

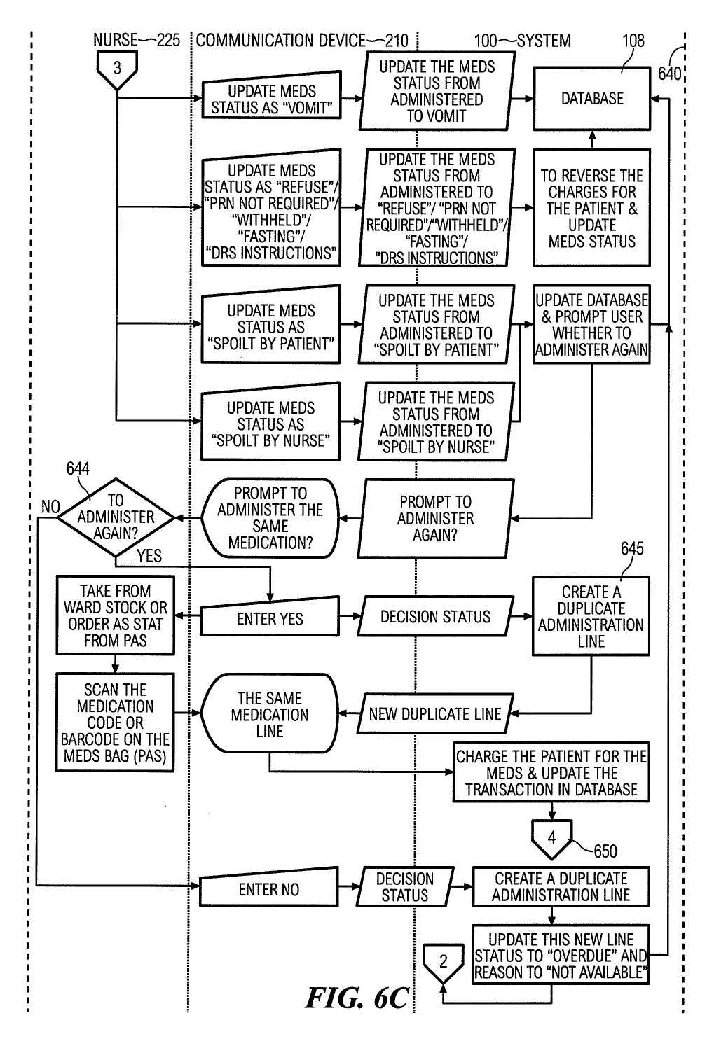

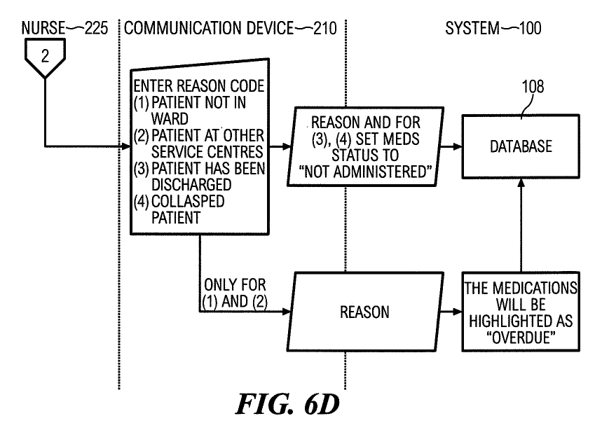

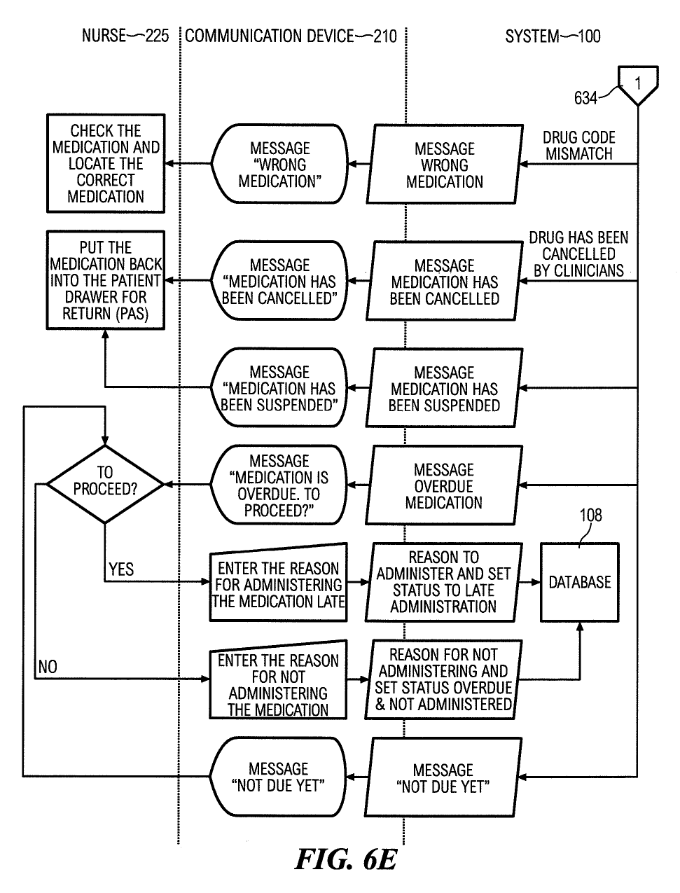

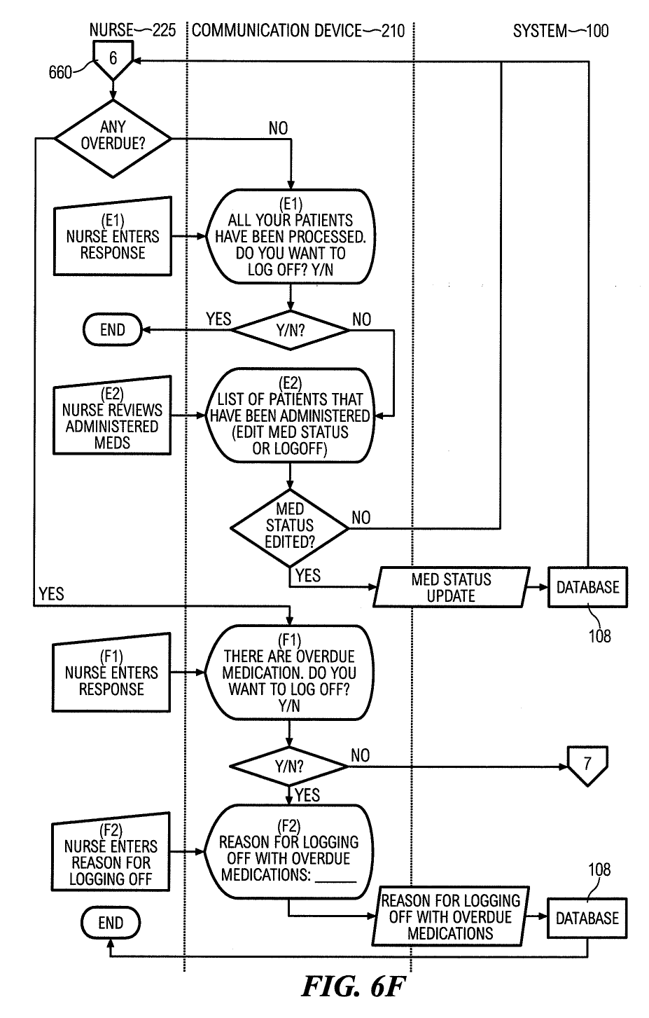

FIG. 6A shows the process flow for a nurse module 600 according to an embodiment of the present invention. Before a nursing round starts, a nurse 225 scans his/her identification card 222-5 at an RFID reader at a nurse station and retrieves, in step 610, a task list from the central database 108. With the task list, the nurse identifies the medicine trolley 300 and moves it to the correct ward. The nurse 225 identifies a patient 227 and scans the patient's RFID tag, in step 620, with the nurse own communication device 210. A validation signal is sent from the nurse's communication device 210 to the central database 108. Once the nurse 225 is identified, information stored in the microchip in the patient's RFID tag is sent to the central database 108 for verification, in step 622. If the patient 227 is positively identified, in step 624, the nurse 225 checks the prescription for the patient, identifies and picks up the container 350 containing the prescribed medication from the drawer 314 on the medicine trolley 300. The antennae 340 and RFID reader 324 detects the medicine container 350 being removed from the drawer 314. The nurse scans, in step 630, the RFID tag 360 on the medication container 350. Information from the RFID reader 324 and RFID tag 360 is compared and a decision is made, in step 632, whether the nurse 225 has picked up the correct medication for the patient 227. If the decision is negative, the nurse 225 is alerted, in step 634, on his/her communication device 210. If the correct medication is picked up by the nurse, the system 100 affirms it, in step 636, and the nurse 225 proceeds to administer the medication, in step 640, to the patient 227 according to the doctor's prescription by the correct route and dosage, and at the correct time. In step 650, the nurse checks whether the medical supplies need to be replenished. If there is a need to replenish a medical supply, the nurse would enter launch the Ordering/requisition software 250 on the portable communication device 210 and enter the relevant fields. Once, a task is completed, the nurse 225 enters, in step 660, into the communication device 210 that the task is completed. Following this, the central database 108 is updated.

In another embodiment of the nurse module 600, the nurse scans the RFID tag 360 on the medicine container 350, in step 630, and then identifies the patient 227 in step 620, instead of scanning the patient's RFID tag first and then look for the prescribed medicine.

As shown in FIG. 6B, the process box 610 in FIG. 6A requires a nurse 225 to input one's identification 222-5 and password into one's communication device 210 before retrieving a task list for a ward.

FIG. 6A shows a nurse process flow for a patient; in FIG. 6B, process box 620 includes a decision point to determine whether all patients in a ward has been attended to. If the decision is negative, the nurse 225 would repeat process 620. If the decision is positive, the nurse 225 would proceed to process 660 to close the task. An implementation of process 660 is shown in FIG. 6F.

When a patient 227 is positively identified, for example, by the patient's RFID tag 414 in one embodiment of process 630 in FIG. 6A, the hospital records system 100 displays a list of medication for the patient, including important information and instructions. Upon retrieving a medicine from the medicine trolley 300, the trolley RFID reader 324 detects the medicine was removed and validates it with the prescription in the system 100. In addition or alternatively, the nurse 225 scans the medicine RFID tag 260 with one communication device 210. If the medicine is correct, the nurse 225 proceeds to administer 640 the medicine to the patient. If the medicine is incorrect, the system 100 outputs relevant messages to the nurse 225 on the communication device according to process 634 shown in FIG. 6E.

During the medicine administering process 634, a check 642 is made whether the medication is spoilt by the nurse 225. If a medicine is spoilt, for example being spilt over or the medical supplies is soiled or damage, the nurse process proceeds to point 3 in FIG. 6B. The nurse sub-process from point 3 is shown in FIG. 6C.

In the nurse sub-process shown in FIG. 6C, a system decision is made whether to administer to the patient again in step 644. If the nurse decides to administer to the patient again, a duplicate administration line is created in step 645; following this, a new supply is ordered or a new supply is taken from a ward stock according to process 650. In an implementation of process 650, the system database 108 and the patient's account are updated before the nurse sub-process proceeds to point 4.

If the decision in step 642 is negative, a check is made whether all the medications have been administered to each patient in the ward. If the decision for a patient in negative, the nurse proceeds with the medical administering process 630 to the next patient in the ward. If the decision is positive, the nurse checks whether the patient is present. If the patient is no longer in the ward, the nurse process proceeds to point 2.

The nursing sub-process from point 2 is shown in FIG. 6D.

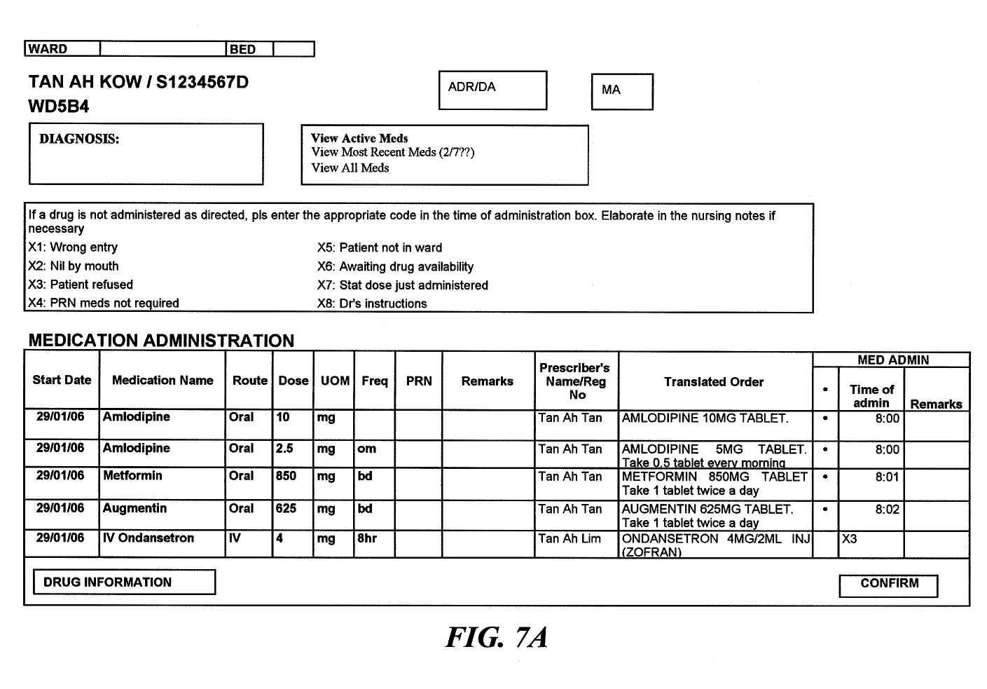

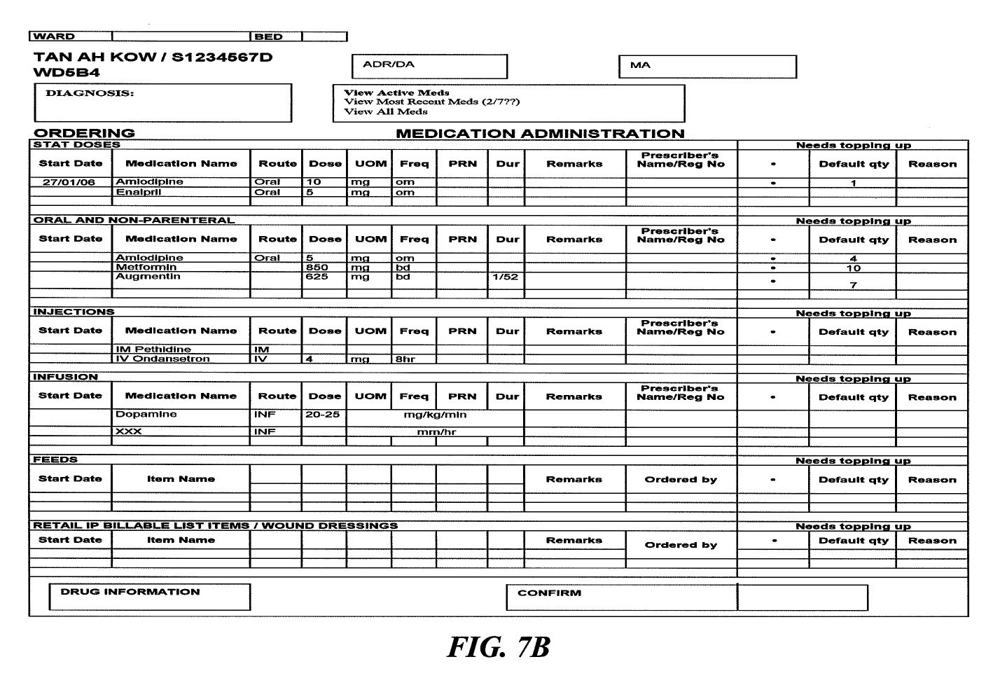

FIG. 7A shows a screen shot illustrating a medication administration function in the nurse module 600, whilst FIG. 7B shows a screen shot illustrating the ordering of medical supplies function in the nurse module 600.

With the present invention, a doctor's prescription, a pharmacist's preparation of the medication and medical supplies, and a nurse's administration of the medication on a patient are automatically monitored, verified and recorded in the central database 108. Together with tagging of each medication and medical supplies, medical errors on the part of the human health care provider is minimized. As a result, the overall hospital information system 160 and other functions of the hospital are also improved.

While specific embodiments have been described and illustrated, it is understood that many changes, modifications, variations and combinations thereof could be made to the present invention without departing from the scope of the invention. For example, a hospital is used in the above description; the present invention may be used in another health care enterprise, such as, a nursing care facility. The RFID antenna 340 may be associated with the open-top tray 312 or open-shelf 316 of the medicine trolley 300 in addition or alternative to the medicine drawer 314.

1. A medical supplies RFID tracking system comprising:
a medicine trolley having one or more storage compartments, a RFID controller, a RFID reader, and a wireless communication unit operable to communicate with a database; and
a communication device issued to a health care staff.

2. A system according to claim 1, wherein the database forms part of an enterprise health care records system, which is hosted on a web.

3. A system according to claim 1 or 2, wherein the RFID controller further comprises an embedded controller, said embedded controller is operable when said medicine trolley is outside a wireless zone of the enterprise health care records system.

4. A system according to any one of claims 1-3, the health care staff comprises at least a doctor, a nurse, a pharmacist and an administration staff.

5. A system according to any one of claims 1-3, wherein the communication device comprises a suite of software modules for staff validation, patient validation, drugs validation, supplies requisition, administration validation, RFID driver, wireless communication driver, and so on, with each software functionality accessible according to a staff function.

6. A system according to claim 5, wherein the software functional access is controlled via a staff identification card.

7. A system according to claim 5 or 6, wherein the communication device comprises a personal digital assistant (PDA), a computer, a portable computer, and a mobile phone, said devices having a display and an input means.

8. A method of tracking a medical supply, the method comprising:
tagging each medical supply with a RFID tag if the supply tallies with a prescription stored in an enterprise records system for a patient;
disposing the RFID tagged medical supply in a storage compartment of a medicine trolley;
tracking the RFID tag of each medical supply;
assessing a relevant record in the enterprise records relating to a patient and comparing each medical supply with the relevant record; and
updating the administering of the medical supply to the patient if the medical supply removed from the storage compartment of the medicine trolley tallies with the prescription for the identified patient, or alerting the medical staff if the medical supply removed from the medicine trolley does not tally with the prescription for the identified patient.

9. A method according to claim 8, wherein comparing each medical supply with a relevant record comprises scanning the RFID tag on the medical supply before scanning a RFID tag on the patient.

10. A method according to claim 8, wherein comparing each medical supply with a relevant record comprises scanning a RFID tag on the patient before scanning the RFID tag on the medical supply.

11. A method according to any one claims 8-10, wherein assessing a relevant record is facilitated via a communication device.

12. A method according to claim 11, wherein the communication device has a RFID reader.

13. A method according to claim 11 or 12, wherein the communication device for a doctor has a doctor software module.

14. A method according to claim 11 or 12, wherein the communication device for a nurse has a nursing software module.

15. A method according to claim 11 or 12, wherein the communication device for a pharmacist has a pharmacy software module.
